(19) United States
(12) Patent Application Publication
(10) Pub. No.: US 2006/0038378 A1
(43) Pub. Date: Feb. 23, 2006

(54) FOLDABLE TRUNK BIKE

(76) Inventor: Yueh-Tao Lee, Kaohsiung City (TW)

Correspondence Address: LEONG C LEI, PMB # 1008, 1867 YGNACIO VALLEY ROAD, WALNUT CREEK, CA, 94598, US

(21) Appl. No.: 10/921,118

(22) Filed: Aug. 19, 2004

(51) Int. Cl. B62K 17/00

(52) U.S. Cl. 280/278; 280/287

(57) ABSTRACT

A foldable trunk bike comprised of a front frame and a rear frame; the front frame containing handle, fork, and front wheel while the rear frame related to a trunk fixed with a retractable crossbar, stay fork, seat tube, rear wheel, drive chain and crank; a mobile pipe connecting the front frame of the bike penetrating into the fixed stand, the handle folded downward, and the entire bike retreated into the trunk to facilitate carriage and towing.

### BACKGROUND OF THE INVENTION

(a) Technical Field of the Invention

The present invention is related to a foldable trunk bike, and more particularly to one having the retracted rear frame of the bike in a trunk and the front frame of the bike together with crossbar and handle retreated into the trunk frame for easy carriage and towing.

(b) Description of the Prior Art

For providing advantages of easy portability, energy saving, life style, and healthy, the foldable bike becomes increasingly popular and helps ease problems of urban pollution and difficulty in finding a parking booth. Therefore, the fordable bike as a light transportation means will be a mainstream in the world.

As illustrated in FIG. 1 of the accompanying drawings, a foldable bike 1 of the prior art is comprised of a fork 11, a seat stay 12 and a cross bar 13 that connects the fork 11 and the seat stay 12. Wherein, a front wheel 111 is provided to where below the fork 11; and a handle 112, above. A rear wheel 121 and a transmission 122 are provided to where below the seat stay 12; a seat tube 123, above the transmission 122; and a seat 124 at the top of the seat tube 123.

When retracted, the bike has its handle 112 above the fork 11 folded downward by releasing a knob 114 adapted to a coupling 113; the knob 114 retightened again to hold the retracted handle 112 in place; another knob 131 adapted to the crossbar 13 released to fold in the fork 11 to where the seat stay 12 is located as illustrated in FIG. 2; the knob 131 locked up; and finally the height of the seat tube 123 reduced to achieve the purpose reducing the size of the bike.

However, the prior art is found with the following flaws: (1) Extra force is required resulting in painful finger(s) by the heavy crossbar 13; (2) The volume is reduced for the retracted bike, but it gets wider and looks a mess without a casing; and (3) It won't be easy to carrying the retracted bike for a longer way.

### SUMMARY OF THE INVENTION

The primary purpose of the present invention is to provide a foldable trunk bike that when folded in will not hurt the finger(s) of the rider. To achieve the purpose, the bike of the present invention is comprised of a front frame and a rear frame connected by a crossbar to retract or stretch both frames by operating a rotary stem adapted to the crossbar.

Another purpose of the present invention is to provide a foldable trunk bike that permits volume reduction when retreated. To achieve the purpose, a trunk is fixed to its rear frame to accommodate the front frame when retracted.

Yet another purpose of the present invention is to provide a foldable trunk bike that it is easy to carry along as with a luggage trolley. To achieve the purpose, a caster is each provided on both sides of the tail of the trunk and the handle becomes the frame of a luggage trolley.

Yet another purpose of the present invention is to provide a foldable trunk bike that when retracted will not become wider to facilitate carrying the trunk.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a foldable bike of the prior art.

FIG. 2 is a schematic view showing the foldable bike of the prior art is retracted.

FIG. 3 is a schematic view of a preferred embodiment of the present invention.

FIG. 4 is a sectional view of the preferred embodiment of the present invention.

FIG. 5 is a schematic view showing a construction of a crossbar of the preferred embodiment of the present invention.

FIG. 6 is a schematic view showing the crossbar as assembled.

FIG. 7 is an exploded view showing a construction of a crank of the preferred embodiment of the present invention.

FIG. 8 is a schematic view showing the crank as assembled.

FIG. 9 is a schematic view showing adjustment of the crank.

FIG. 10 is a schematic view showing that the preferred embodiment of the present invention is retracted.

FIG. 11 is a side view of the preferred embodiment of the present invention as retracted.

FIG. 12 is a schematic view showing the towing of the preferred embodiment of the present when retracted.

FIG. 13 is another schematic view showing that the preferred embodiment of the present invention is retracted.

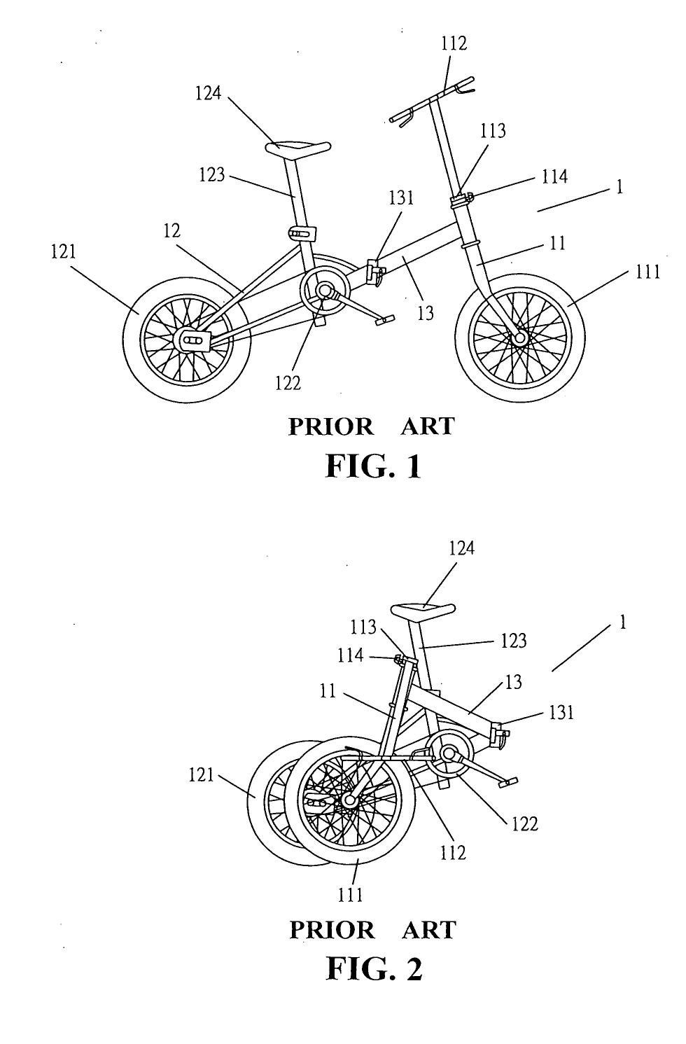

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

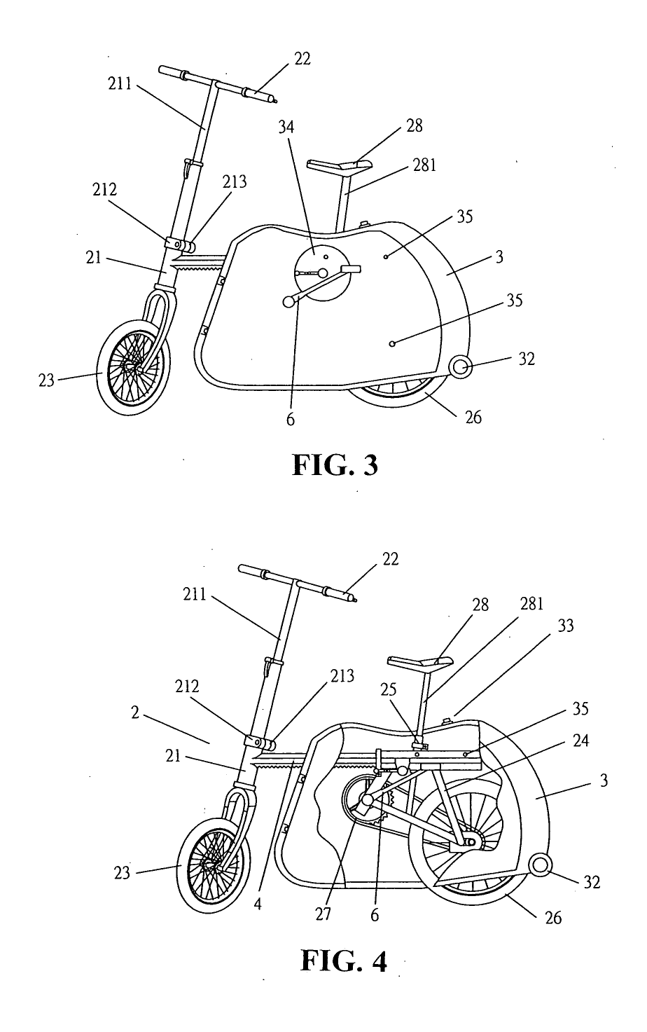

Referring to FIG. 3 for a preferred embodiment of the present invention, a foldable trunk bike 2 is essentially comprised of a front frame and a rear frame. Wherein, the front frame includes a fork 21, a handle 22, and a front wheel 23 as illustrated in FIG. 4 while the rear frame has a crossbar 4 fixed to the inner side of a trunk 3, and the crossbar 4 is integrated with a seat stay 24, a seat tube holder 25, and a rear wheel. A crank 6 penetrates both sides of the trunk 3 and connects to an axle of a drive chain 27; and the trunk 3 is fixed to the crossbar 4 with multiple screws 35.

The front wheel 23 is fixed to where below the fork 21, and the handle 22 is connected to a head tube 21 extending from the fork 2. By releasing a knob 213 adapted to the coupling 212, the handle 22 is folded downward to rest on the fork 21 as illustrated in FIG. 11; and the knob 213 is retightened again for the handle 22 to be secured on one side of the fork 21. It is to be noted that the front frame of the present invention falling within the scope of the teaching by the prior art.

A crossbar 4 is fixed in the trunk 3 in a size merely sufficient to accommodate both of the front and the rear frames when folded in as illustrated in FIG. 4. A front cover 31 is provided to the trunk 3. Two holes 311, 312 are respectively provided in the upper part and the front of the front cover 31 to permit penetration by a seat tube 281 and the head tube 211 of the fork 21. The rear end of the crossbar 4 is connected to the seat stay 24, and the rear wheel 26 is fixed to the tail of the seat stay 24. The seat tube holder 25 is fixed at the middle of a fixed stand 41 of the crossbar 4 for the placement of the seat tube 281 provided at its top a seat 28.

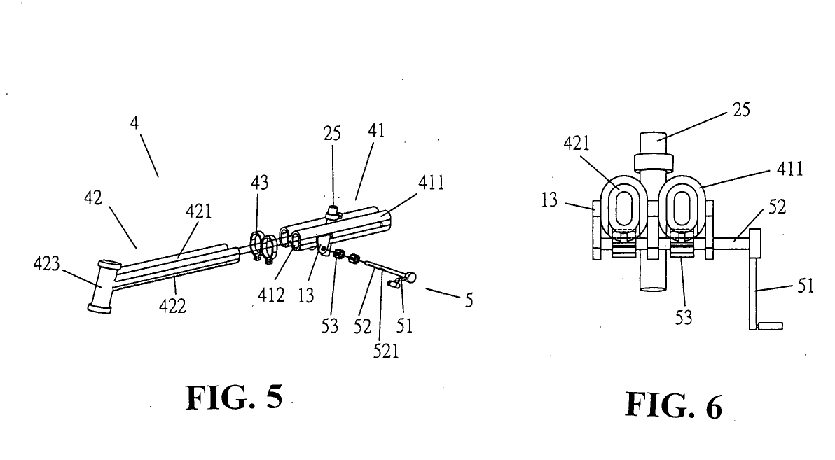

Now referring to FIG. 5, the crossbar 4 is comprised of a fixed stand 41 and a mobile stand 42. Wherein, a seat tube holder 25 is vertically provided to the fixed stand 41 at where between two tubes 411 arranged in parallel. A gap is provided at the lower edge of a front end 412 of each tube 411, and four flaps 413 are fixed to the external wall of both tubes 411 at where in relation to the inner edge of the gap for the insertion of a rotary stem 5. The rotary stem 5 includes a rotary lever 51, an axle 51, and two tube gears 53. The rotary lever 51 is pivoted to the axle 52 for respectively placing both gears 53 at where between those four flaps 413 of both tubes 411. A tip 521 fixed to the axle 52 is engaged into the tip of the axial hole provided on each gear 53 so that both gears 53 on the axle 52 turn synchronously when the rotary lever 51 is turned.

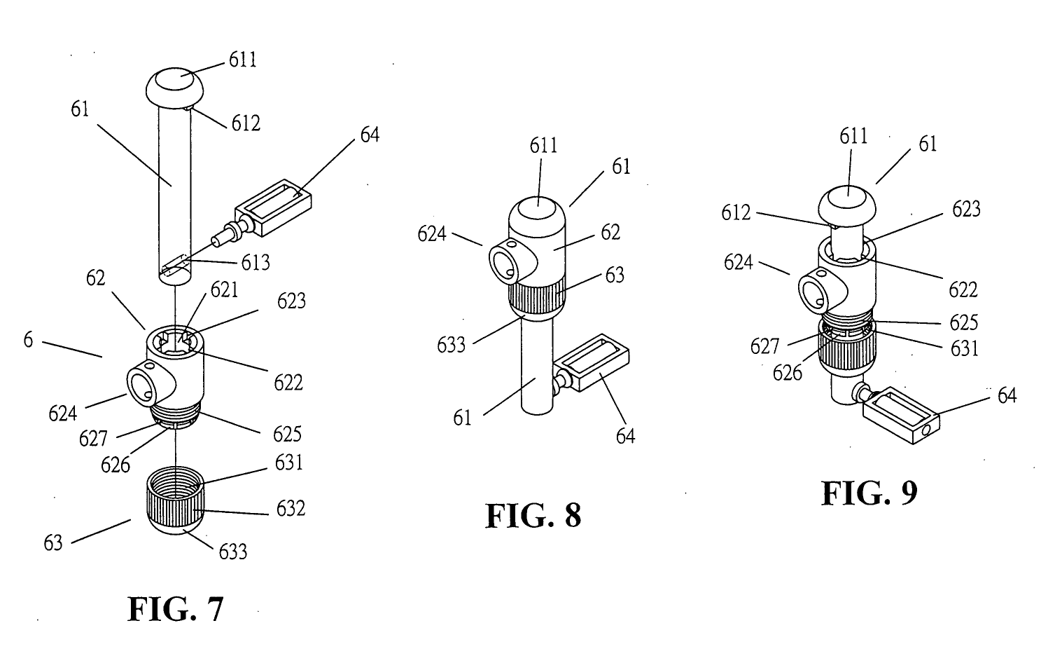

The mobile stand 42 of the crossbar 4 is comprised of two tubes 421 in parallel with each other. A fork sleeve 423 is fixed to the front of both tubes 421 of the mobile stand to secure the penetration of the head tube 211 of the fork 21. Meanwhile, a rack 422 is fixed to the bottom of each tube 421 to permit the tube 421 to penetrate into the tube 411 of the fixed stand 41 as illustrated in FIG. 6. Accordingly, the rack 422 at the bottom of each tube 421 of the mobile stand 42 is merely engaged with the gear 53 of the rotary stem 5. When the rotary stem 5 clockwise or counter-clockwise, the mobile stand 42 retreats into or extends from the fixed stand 41. To make sure that the mobile stand is firmly secured, a ring clip 43 is disposed to the end 412 of each tube 411 of the fixed stand 41 at where the gap is provided when the crossbar 4 is adjusted to stay in position as illustrated in FIGS. 5, and 6.

Whereas the crank 6 of the bike penetrates outside the trunk 3 to be engaged to the axle of the drive chain 27, the crank 6 and a pair of pedals attached to it must be able to turn and rest on the external wall of the trunk 3 for achieving the purpose of reduced volume. Therefore, the crank 6 has a crank rod 61 to penetrate through a crank holder 62 as illustrated in FIG. 7 and is then locked up at the end of the crank holder 62 with an adjustment nut 63 before screwing the pedal 64 to the crank rod 61. Wherein, the crank rod 61 is provided with a head in larger diameter as illustrated in FIG. 8, and two protruding bits 612 are provided 180° apart from each other to the lower edge of the head 611. A screw hole 613 is provided at the lower end of the crank rod 61 for the pedal 64 to screw in. Two pairs of abutted fillisters 622, 623 arranged at right angle to one another are provided on the top end surface of the tube disposed with a central hole 621 for the crank holder 62, and an axial branch 624 extends from one side of the crank holder 62 to be screwed the axial of the drive chain 27. A thread 625 is provided on the tube below the crank holder 62 and multiple gaps 627 at a given spacing are provided to the lower edge 626 of the crank holder 62 with the lower edge in a slightly diminished diameter. The nut 63 is screwed to the lower edge 626 of the crank holder 62 and is provided a thread 631 on the inner wall and a female thread 632 is provided on the outer wall. A lower end 633 of the nut 63 is tapered to facilitate rotating by the rider of the bike.

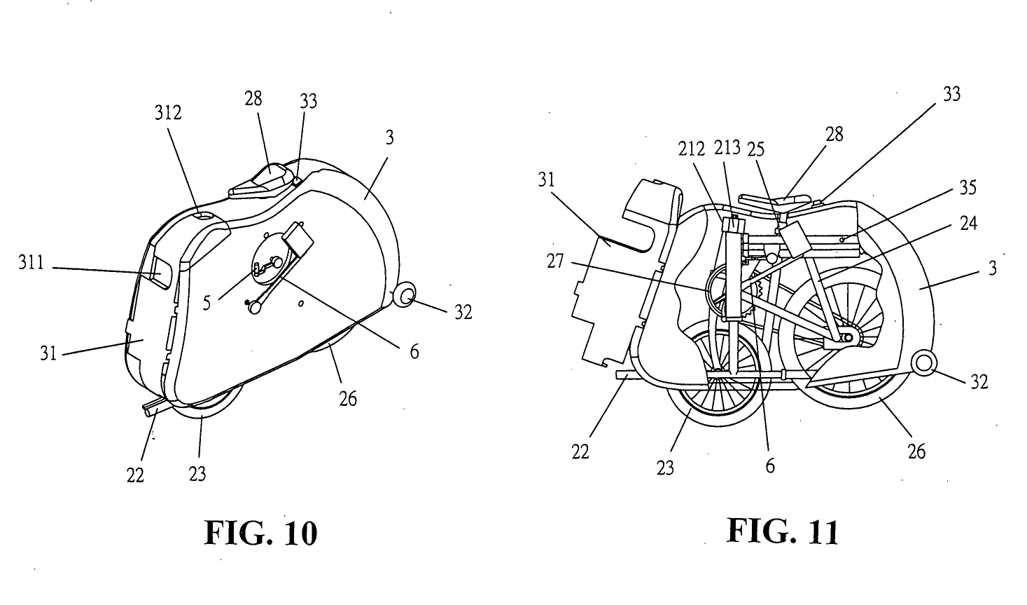

To ride the bike, the crank rod 61 has those protruding bits 612 under the nut inserted to those fillisters 622 provided in parallel with the axial branch 624 and tightened with the nut from the end of the crank holder 62. The crank rod 61 is fastened in position by having the lower end 633 of the nut 63 to fasten the lower edge 626 of the crank holder 62. Accordingly, both pedals 64 are adjusted to a position at right angle to the trunk 3 for the rider to step on them. To fold in the bike, the nut 63 is released; the crank rod 61 is turned for 90° to cause both protruding bits 612 below the nut 63 to be inserted to respective fillisters 623 vertically disposed to the branch 624 as illustrated in FIG. 9; and finally the nut 63 is tightened up to have both of the crank rod 611 and the pair of the pedals 64 to rest on their respective fillisters 34 provided on the surface of the trunk 3 as illustrated in FIG. 10 to reduce the volume of the crank rod 611 and the pair of the pedals 64 protruding from the trunk 3.

Now referring to FIG. 3, the biker sits on the seat 28 and steps onto both pedals 64 with both feet striding over both sides of the trunk 3. Whereas the trunk 3 covers up the rear frame to expand the volume of the bike to make the appearance of the bike is more attractive and avoid any awkwardness the rider may have by riding a small bike.

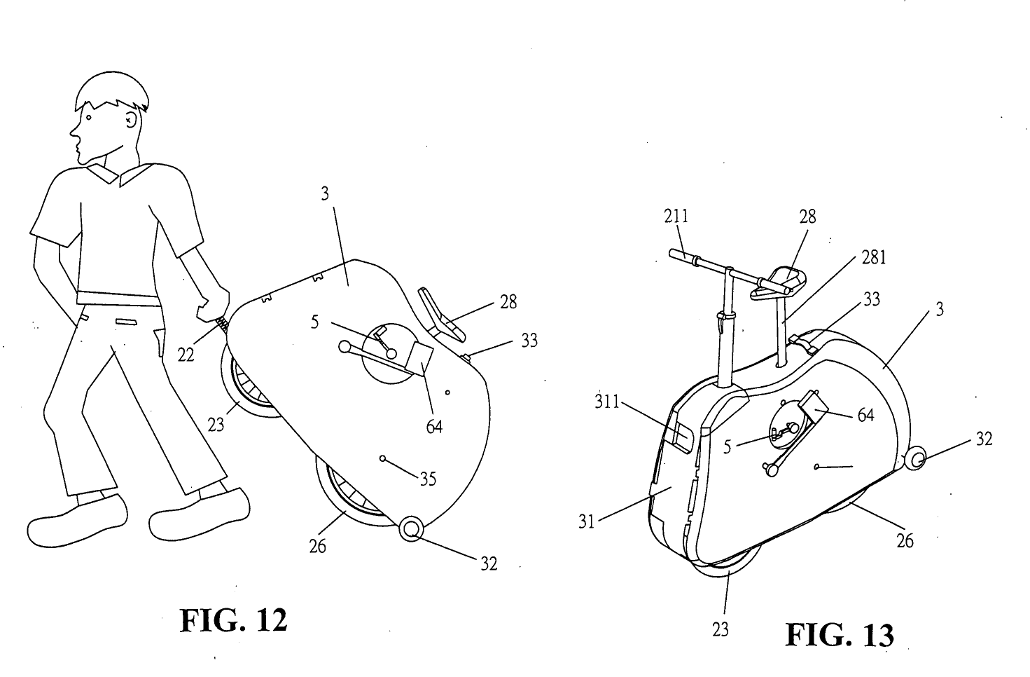

At times, the biker may drive his car to a certain destination to enjoy the fun of riding a bike, and the bike is folded in and placed in the trunk of the car. To store the bike, first the front cover 31 is lifted up as illustrated in FIG. 11; the handle 22 is turned for 180° to fold in both of the fork 21 and the front wheel 23 to where within the range of the crossbar 4; and the handle 22 is then folded downward and fastened with the knob 213 for the rider to poke his fingers into the trunk to release the clamps 43 on the mobile stand to turn the rotary stem 51 for both gears 53 to drive the rack 422 at the bottom of the mobile stand 41 as illustrated in FIG. 6. Both tubes 411 of the mobile stand 41, and the fork, the handle and the front wheel fixed to the mobile stand 41 are retreated into the trunk 3. The front cover 31 of the trunk 3 is let down and the rotary lever 51 is turned to rest in the fillisters 34 on the outer wall of the trunk 3 to diminish the volume of the protruding rotary lever 51. Finally, the seat tube 281 is treated to leave only the seat exposing out of the upper edge of the trunk 3 to complete the retraction of the bike without the risk of getting finger(s) hurt and the retracted bike looks like a suitcase.

Whereas one end of the handle sticks out of the trunk 3 for a small section, the biker could grab it to carry the bike. To facilitate towing, a caster 32 is each fixed to both sides at the lower edge in the tail of the trunk 3 as illustrated in FIG. 12. In case of stairs or any other place that prevents the towing, the biker simply carries the retracted bike by a handle 33 provided on the top of the trunk 3.

Furthermore, as illustrated in FIG. 13, only the fork, the handle and the front wheel are folded into the trunk 3 will significantly reduce the volume of the bike to spare three times of parking space, an advantage particularly welcome by any office building with very limited area for parking.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-6. (canceled)

7. A foldable trunk bike comprising a front frame and a rear frame connected by a crossbar, wherein the front frame has a fork, a handle, and a front wheel connected in one piece; the rear frame has a seat stay, a rear wheel, a seat tube holder, a drive chain and a crank connected in one piece; the crossbar is fixed to a trunk to accommodate the rear frame of the bike; the front frame is folded into the trunk; the crossbar has a fixed and a mobile frames; a front of the mobile front is fixed to the fork; the crossbar is fixed to the seat stay; the trunk fixed to the crossbar covers up both of the front and the rear frames of the bike when folded in; both side panels of the trunk are streamlined; a hole is each provided on front and rear of each of the side panels to permit penetration of the seat tube and the fork; a front cover capable of being lifted up is provided to the trunk; and the front cover is provided with holes to permit penetration of the crossbar and the fork.

8. The foldable trunk bike of claim 7, wherein a caster is each provided to a lower edge of a tail of the side panels of the trunk fixed to the crossbar, and a handle is provided on a top of the trunk.

9. The foldable trunk bike of claim 7, wherein, both of the front and the rear stands are connected by the crossbar; both of the fixed and fixed stands of the crossbar have gears as the mechanism for retreating or extending into or from each other to retract the front frame into the trunk.

10. The foldable trunk bike of claim 9, wherein the crossbar has a mobile stand, a fixed stand and a rotary stem; a fork sleeve is fixed to a front of both tubes arranged in parallel to each other of the mobile stand; the fork penetrates the sleeve; a rack is fixed along an axial line extending from the both tubes; the fixed stand has two tubes parallel with each other respectively fixed to both sides of the seat tube; a gap is provided at a lower edge at a front of each tube; multiple flaps are respectively fixed to both sides of the tubes in relation to the inner edge of the gap; holes are provided on the flap to receiver insertion of the rotary stem; a rotary lever being bolted to one end of an axial of the rotary stem; and two gears are inserted to the axial at where merely in relation to the gaps of the tubes are located.

11. The foldable trunk bike of claim 7, wherein the crank is screwed to the drive chain; the crank has a crank rod to penetrate through a crank holder and secured with an adjustment nut to the lower end of the crank holder; a pair of pedals are screwed to the crank rod; two pairs of abutted fillisters arranged at right angle to one another are provided on the top end surface of the tube disposed with a central hole for the crank holder; an axial branch extends from one side of the crank holder to be screwed to an axle of the drive chain; a thread is provided on the tube below the crank holder and multiple gaps at a given spacing are provided to the lower edge of the crank holder with the lower edge in a slightly diminished diameter; the nut is screwed to the lower edge of the crank holder and is provided a thread on the inner wall and a female thread is provided on the outer wall; and the lower end of the nut is tapered.
